(19) United States
(12) Patent Application Publication
(10) Pub. No.: US 2021/0317679 A1
(43) Pub. Date: Oct. 14, 2021

(54) COLLAPSIBLE INFECTIOUS DISEASE ISOLATION TENT AND METHOD OF OPERATION

(71) Applicants: FlexSys Inc., Ann Arbor, MI (US); The Regents of the University of Michigan, Ann Arbor, MI (US)

(72) Inventors: David Hornick, Ann Arbor, MI (US); Sridhar Kota, Ann Arbor, MI (US); Benjamin S. Bassin, Ann Arbor, MI (US); Kevin R. Ward, Superior Township, MI (US)

(21) Appl. No.: 17/093,723

(22) Filed: Nov. 10, 2020

Related U.S. Application Data
(60) Provisional application No. 63/007,978, filed on Apr. 10, 2020.

(51) Int. Cl. E04H 15/14; A61G 10/00; E04H 1/12

(52) U.S. Cl. CPC E04H 15/14; E04H 1/1277; A61G 10/005

(57) ABSTRACT

A collapsible isolation tent assembly includes a collapsible frame assembly, a flexible skin of impermeable material, and an air exchange arrangement, and further an air pump configured for being connected to the air exchange arrangement to effect a unidirectional air flow through the air exchange arrangement. The air pump has a pump capacity within the range of 85 per minute through 20,000 liters per minute. Openings in the flexible skin or around edges of the collapsible tent allow for an air flow compensating for the unidirectional air flow created by the air pump, and the collapsible isolation tent has a footprint dimensioned to be placed on a support surface for an individual patient, for example a hospital bed. A method for preventing air containing airborne pathogens from contaminating a surrounding space or the interior of the isolation tent involves operating an air pump in fluid communication with the collapsible tent.

### TECHNICAL FIELD

The present disclosure deals with a tent preventing air containing airborne pathogens from contaminating a surrounding space for isolating a carrier of an infectious disease from the environment.

### BACKGROUND

The COVID-19 pandemic has put a severe strain on hospital environments and intensive care units (ICUs). Extensive efforts have been undertaken to provide adequate personal protective equipment (PPE) and isolation equipment (including the use of negative pressure rooms) to ensure patient and health care worker safety. However, many countries continue to have shortages of both, and some therapies for COVID-19 are associated with high rates of aerosolization, which increases the safety threat faced by health care workers and other patients. Efforts to mitigate these risks are therefore paramount for the safety of patients and health care workers.

Patients with COVID-19 may require aerosol generating procedures (AGP) or therapies (including intubation, extubation, nebulized breathing treatments, non-invasive ventilation [NIV], heated high-flow nasal cannula [HFNC], tracheostomy, and cardiopulmonary resuscitation). These factors amplify the risks faced by health care workers and are further magnified in low- to middle-income countries, where access to safety equipment may be limited. Physicians' fear of contracting the virus could lead to deviations from standard care.

### SUMMARY

Strategies to mitigate these risks are highly desirable. “Clinical distancing,” a parallel to the practice of social distancing, is a desirable objective for health care workers to avoid unnecessary contact with patients to reduce transmission.

To meet this goal, the present disclosure describes, according to a first aspect of the invention, a collapsible isolation tent assembly comprising a collapsible isolation tent having a collapsible frame assembly, a flexible, preferably transparent, skin of impermeable material, and an air exchange arrangement, and further comprising an air pump configured for being connected to the air exchange arrangement to effect a unidirectional outward or inward air flow through the air exchange arrangement, preferably equipped with a HEPA filter. The air pump has a pump capacity within the range of 85 liters per minute through 20,000 liters per minute. Openings in the flexible skin or around edges of the collapsible tent allow for an inward air flow compensating for the unidirectional outward air flow through the air pump or for an outward air flow for compensating for the unidirectional inward air flow through the air pump, respectively.

The collapsible isolation tent is dimensioned to have a footprint with a width within the range of 35 cm through 140 cm and a length within the range of 30 cm through 200 cm. This small size allows the collapsible tent to be placed on a support surface for an individual patient, for example a hospital bed.

According to a further aspect, the air pump is adjustable to create an air pressure difference between air in an interior space inside the collapsible isolation tent and air in an exterior space surrounding the collapsible isolation tent. For example, the pressure difference may be within a range of 34 Pa to 17,000 Pa.

Alternatively or additionally, the collapsible isolation tent and the air pump may be dimensioned for exchanging the air in the interior space within a range of 0.2 to 100 times per minute.

According to another aspect of the invention, the air exchange arrangement may comprise a port and a filter receptacle in communication with and upstream of the port. The filter receptacle has an opening toward the interior space of the tent and is configured to receive a filter. If the collapsible tent is configured for repeated use, the filter receptacle may be configured for replacing the filter in the form of a filter insert.

Generally, the filter is arranged upstream of the air pump so that clean air passes through the air pump.

According to yet another aspect of the invention, the flexible skin may be configured for custom slits and openings being cut by a health care provider for accessing specific locations inside the collapsible isolation tent from an exterior space and for adjusting a pressure difference between the exterior space and an interior space of the collapsible isolation tent. These slits are customizable for providing access for aerosol generating procedures (AGP) or therapies (including intubation, extubation, nebulized breathing treatments, non-invasive ventilation [NIV], heated high-flow nasal cannula [HFNC], tracheostomy, or cardiopulmonary resuscitation).

In one embodiment of the invention, the collapsible frame assembly includes a support base that surrounds an interior area on three of four sides and having one open side, the interior area having a length of about 29 cm to 199 cm and a width between about 34 cm and 139 cm. The collapsible frame assembly may have an expanded state with an overall height within the range of 20 cm through 185 cm.

For ease of visual access, the flexible skin may be translucent or transparent and made of pliable plastic sheeting.

Additionally, the flexible skin may comprise a drapable curtain at an end opposite from the head end. Such a curtain may rest on a patient's body without the need for a closure mechanism.

According to a further aspect of the invention, a method for preventing air containing airborne pathogens from contaminating a surrounding space or an interior space of a collapsible tent having a footprint sized to be placed on a hospital bed involves operating an air pump in fluid communication with the interior space of the collapsible tent to pump air into or out of the interior space through a filter.

Prior to operating the air pump, the collapsible tent may be placed on a surface configured for carrying an infected patient.

The pump may be operated to maintain a control parameter within a specified range. This control parameter range may be an air flow within the range of 85 liters per minute through 20,000 liters per minute or any sub-range within this range. Alternatively or additionally, the control parameter may be a pressure difference between the interior space and an exterior space within the range of 34 through 17,000 Pa or any sub-range within this range. Additionally, or alternatively, the pump may be operated to exchange the air volume inside the collapsible tent within the range of 0.2 through 100 times per minute (based on a large pump used with a small tent) or within any sub-range of this range.

The method may further involve the step of cutting access openings in a tent skin for adjusting an inflowing air flow.

The method may further involve the step of filtering the air in a flow path from the interior space to the pump with a filter material suited for removing at least a part of the airborne pathogens from the air in the flow path.

Further details and benefits of the collapsible isolation tent will become apparent from the following description of an example shown in the appended drawings. The drawings are provided herewith for purely illustrative purposes and are not intended to limit the scope of the present invention.

### BRIEF DESCRIPTION OF THE DRAWINGS

In the drawings,

FIG. 1 shows a side view of a frame assembly of a collapsible tent according to the present disclosure, with a skin indicated by broken lines;

FIG. 2 shows a fully assembled isolation tent according to the present disclosure, with a schematically drawn attached air pump;

FIG. 3 shows the tent of FIG. 2 from a view point underneath the tent with a schematically drawn outline for illustrating dimensions and features; and

FIG. 4 shows the frame of FIG. 1 in a collapsed state, ready for storage and/or transportation; and

FIG. 5 shows a flow chart of a basic operation of an individual isolation tent.

### DETAILED DESCRIPTION

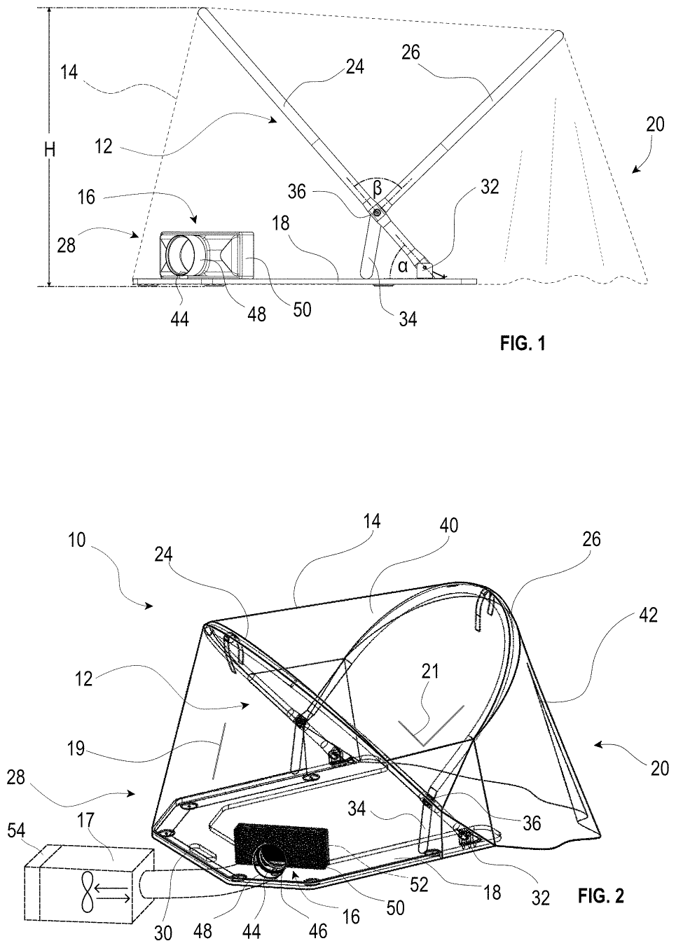

FIGS. 1, 2, and 3 show an example of an isolation tent 10 of the present disclosure. To increase treatment options in areas of widely spread infections, in particular during a pandemic, the present disclosure provides a collapsible individual isolation tent 10 that prevents unfiltered exhalants from a patient from entering the surroundings or, alternatively, surrounding pathogens from reaching the airways of a vulnerable person. The tent 10 is a collapsible structure sized to accommodate at least the head and upper torso of a person.

The isolation tent is composed of a frame assembly 12, a clear skin 14 of air-impermeable material, and an air exchange arrangement 16. The collapsible frame assembly 12 of the isolation tent 10 has a rigid bottom support base 18 formed making a two-dimensional contact with a support surface, such as a hospital bed. For example, the support base 18 may be U-shaped or V-shaped, surrounding an area 22 sufficiently large to accommodate a head and a torso, while being open on one side, where the remainder of the patient's body is positioned outside of the isolation tent 10. Suitable dimensions of the support base provide an interior area 22 with a width w of about 34 to 139 cm between frame elements 24 and 26 to accommodate the shoulder width of a patient, who may be an infant, a child, or an adult. The overall width W of the support base 18 ranges between 35 and 140 cm and be selected to fit within the width of any given hospital bed. For patients of varying body dimensions and for differently sized hospital beds, the isolation tent 10 may be provided in different sizes. From the head end of the interior area 22 defined by the support base to the open side 20 of the support base, the interior area 22 may have a length of about 29 cm through 199 cm. The resulting footprint of the isolation tent 10 is thus within the range of 35 cm through 140 cm in width W and within the range of 30 cm through 200 cm in length L, suited to accommodate an individual patient's head and torso, or the entire body, and to be placed on a hospital bed. The support base 12 of the shown isolation tent 10 surrounds, on three of four sides, the interior area 22 of about 34-139 cm in width w and about 29-199 cm in length s. The term “about” is used to define a variation of plus/minus 5 cm for length measurements and plus/minus 10 degrees for angular measurements. The respective measurements are shown in the drawings in FIGS. 1, 3, and 4 as appropriate.

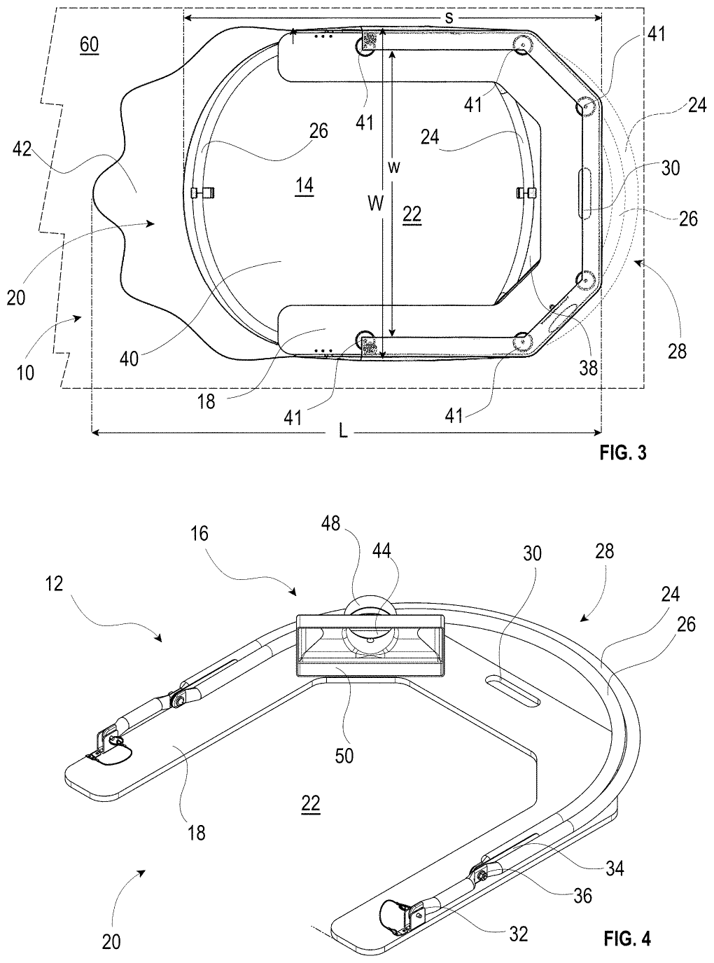

At least two frame elements 24 and 26 are hingedly attached to the bottom support base 18, at least indirectly. Preferably, the frame elements 24 and 26 are shaped to align with the bottom support base 18 when folded down into the collapsed state, at least on the lateral sides as shown in FIGS. 3 and 4. The principle of the foldable frame elements 24 and 26 is similar to that of a canopy for an infant stroller. At the head end 28 of the shown example, the support base 18 has a handle 30, formed in this example as a cut-out placed in a location that does not interfere with the collapsed frame elements 24 and 26 to provide easy access to the carry handle 30 without the risk of pinching the person carrying the collapsed tent 10. In the example shown, the foldable frame elements 24 and 26 are U-shaped bails, with a primary bail 24 hingedly attached to the support base 18 and with a secondary bail 26 hingedly attached to the primary bail 24. Alternatively, all hinged frame elements may be directly connected to the bottom support base 18.

A primary hinge 32 is positioned on each lateral arm of the support base 12 near the open side 20. As the primary bail is intended to generally align with the support base 18 in the collapsed state, the distance of the primary hinge 32 from the open end 20 of the support base 18 is chosen to achieve a desired tent height H within the range of 20 cm through 185 cm in the expanded state of the tent 10. The primary and secondary bails 24 and 26 may be made of extruded and bent PVC tubing or of lightweight metal, while the support base 18 may be formed of a molded thermoplastic polymer, of a lightweight metal material, or of a composite material.

The frame assembly 12 further includes a stabilizing element 34 on each lateral side, which is shown as a fold-out support strut 34 supporting the primary bail 24 on each lateral side against collapsing. The shown support strut 34 is hingedly attached to the primary bail 24 to be folded down after the primary bail is erected so that the support struts 34 form a triangular structure with the primary bail 24 and the support base 18. In the shown example, the secondary bail 26 is connected to the primary bail 24 in the same hinge 36 as the support strut 34. Alternatively, the support strut 34 and the secondary bail 26 may have separate hinges that may also be on the support base instead of the primary bail 24.

The maximum angle between the secondary bail and the support base or between the secondary bail and the primary bail may be limited by the hinge 36 itself. Alternatively, suitable straps on the tent skin extending to the inside of the tent may secure the secondary bail in its expanded condition. In the expanded configuration of the isolation tent 10 as shown in FIGS. 1 and 2, the angle α between the primary bail 24 and the head end 28 of the support base 18 is between 40 and 60 degrees, while the angle β between the secondary bail 26 and the primary bail 24 is between 70 and 110 degrees. In the shown example, the angle α is within a range of 45 to 55 degrees, in particular between 48 degrees and 50 degrees, and the angle β is between 85 and 95 degrees, in particular between 88 degrees and 92 degrees.

At least two flexible clear skin segments 38 and 40 form the skin 14 of the tent 10. A first skin segment 38 extends from the support base 18 to the primary bail 24, and a second skin segment 40 extends from the first frame element to a second frame element. These clear skin segments 38 and 40 are heat-bonded or sewn to each other, following the curvature of the primary bail 24. The skin segments 38 and 40 may fold when the tent structure is collapsed. Alternatively, the skin 14 may be removed and stored separately when the frame assembly 12 is collapsed.

For allowing access to a patient positioned inside the tent, the clear skin segments 38 and 40 may have slits, holes, or slide-in openings in certain locations along the periphery of the tent. In the shown example, however, the skin segments 38 and 40 are formed as continuous sheets and are configured to be slit in custom locations to provide access to the interior of the skin wherever needed or desired. These slits 19 are customizable for providing access for aerosol generating procedures (AGP) or therapies (including intubation, extubation, nebulized breathing treatments, non-invasive ventilation [NIV], heated high-flow nasal cannula [HFNC], tracheostomy, or cardiopulmonary resuscitation). The skin, which is preferably transparent or at least translucent, may be made of a material allowing for such custom slits 19 being cut into the skin. For example, the skin may be made of clear polyethylene or polyvinyl chloride (PET or PVC) of a thickness within a range of 2 mil to 80 mil (0.05 mm to 2 mm) for an optimal combination of transparency, pliability, and tear resistance.

The first and second skin segment are releasably secured to the support base as shown in FIG. 3, where connectors 41 are positioned in six locations arranged along the outer edge of the support base 18. These connectors 41 may, for example, be formed of snaps or of hook-and-loop pairings, known under the brand name VELCRO.

The skin 24 further includes a curtain 42 attached to the second skin segment 40 along the curvature of the secondary bail 26. The curtain 42 is cut to have a width allowing for loosely draping the curtain around a body of a patient. The curtain has an unattached bottom edge of a length corresponding to at least equal to the overall width W.

Affixed to the bottom support base near the head end 28 is the air exchange arrangement 16 establishing a connection from the outside to the inside of the collapsible tent. The air exchange arrangement 16 has a port 44 configured for attaching the suction side of an air pump 17. FIG. 2 shows a schematic illustration of the air pump 17 connected to the port 44 to draw air out of the isolation tent 10 or to pump air into the isolation tent. The tent 10 is dimensioned to withstand an air flow of about 85 liters/min to about 20,000 liters/min. It is desirable that the air pump 17 is a high-volume air pump to ensure that the air flow remains unidirectional, i.e. outward through the air exchange arrangement 16 and inward through openings in and around the flexible skin 14, or vice versa. Generally, the free air volume surrounded by the flexible skin 14 is replaced between about 0.2 and 100 times per minute, most commonly within the range of two to twenty times per minute. The free air volume depends on the size of the tent 10 and the size of the patient placed in the tent 10. Cuts and openings may be manually added to the flexible skin 14 for providing a sufficient influx or outflow of air to compensate the air flow volume generated by the air pump 17 without creating an excessive pressure difference within the tent 10. The high air flow volume ensures that the air flow remains unidirectional. The air flow through all peripheral openings other than the air exchange arrangement 16 is inward when a suction pump is used and outward when a blower pump is used.

The pressure difference between the surrounding environment and the interior of the tent 10 may be maintained within a range of 34 Pa to 17,000 Pa to keep patients comfortable. This pressure difference designates a lowered interior pressure for a suction pump 17 and a raised interior pressure for a blower pump 17. As it is desirable to maintain a high flow volume, additional openings may be cut into the flexible skin as needed on a case-by-case basis. The air flow volume depends on the interior free volume within the tent 10. For example a larger tent accommodating a smaller body will require a greater air flow than a smaller tent accommodating a larger body. The number and sizes of openings for optimizing the air flow depend on the set pump capacity of the air pump 17 and can be added as needed. For example, FIG. 2 shows a slit 19 cut into the first skin segment 38 and a further slit 21 cut into the second skin segment 40 after assembly. While one or more pre-set access openings may be implemented during manufacturing of the flexible skin 14, this is not necessary as additional slits and openings can be easily and safely applied as needed.

The first skin segment 38 has a circular hole 46 to provide an air path between the exterior and the interior of the tent 10. This hole 46 may be premanufactured and may be cut during assembly of the tent 10. The circular hole 46 may be the only premanufactured opening extending through any of the skin segments 38 and 40, including the curtain 42. All other openings, for example the slits 19 and 21 shown in FIG. 2 may be added after assembly to meet custom needs. The port 44 may have a tubular projection 48 extending through the hole 46 so that attachment of the air pump 17 to the port 44 holds the first skin segment 38 in place on the port 44.

Furthermore, a filter receptacle 50 is placed in the air path extending through the port 44 so that any air entering or exiting through the port 44 passes through the filter receptacle 50. The tubular projection 48 is formed on the filter receptacle 50. The filter receptacle 50 is dimensioned to hold a filter 52 for effectively filtering out pathogens. The filter 52 may be a HEPA filter or made of customized components to filter out particles of specific sizes as needed. The filter receptacle 50 may have an opening toward the interior of the tent 10 to make the filter 52 replaceable. This may be of benefit if the tent 10 is intended for repeated use. This filter arrangement in the filter receptacle 50 is primarily intended for use with a suction pump 17 evacuating the collapsible tent 10. In situations where the pump direction is reversed and air is pumped into the tent 10 by a blower pump 17, a filter 54 is preferably arranged upstream of the pump 17 so that the filter 54 is upstream of both the pump 17 and the port 44 and only filtered air passes through the pump 17.

The air pump 17 attachable to the tubular projection 48 is configured to draw air out of the tent 10 to prevent air from the inside of the tent from spreading in the surroundings, for example if the person whose head is located in the tent is a carrier of a disease communicable by aerosols or droplets. If the air pump 17 blows air into the tent, the filter 54 may be used as an additional or alternative filter as part of the pump 17. In any event, the air pumped out of or into the tent is being cleaned upstream of the pump 17 to minimize the communication of pathogens through the pump.

The isolation tent 10 is not intended to be hermetically closed. Rather, it has sufficiently sized gaps to supply an influx of exterior air for replacing the air evacuated by a pump attached to the port 44 or, conversely, to allow any air volume added by the pump to exit the tent 10 through the gaps. If the pump capacity is sufficient, the curtain may not even be required. Accordingly, the underlying principle is not that of creating an airtight chamber, but that of ensuring a unidirectional airflow, where contaminated or potentially contaminated air is cleaned before entering the tent or before being released to the atmosphere, depending on the airflow direction.

To prevent contamination of the exterior surroundings, the gaps are dimensioned such that the pump is capable of creating a sufficient vacuum to ensure that all tent openings and gaps other than the pump port 44 will only provide an influx of air into the tent. Conversely, the gaps must be large enough to prevent the air stream from pulling the curtain 42 into the tent 10. If desired, the bottom edge of the curtain 42 may be weighted to resist the pulling force of the vacuum. If, on the other hand, the tent is used to protect a vulnerable patient, the pump must be able to produce enough air pressure inside the tent 10 such that all airflow through openings other than the pump port 42 only provide an outflow of air.

The overall concept is thus that the tent 10 defines an interior cavity that is in communication with the outside and is closed on one end with a loosely draped curtain 42 with an unattached bottom edge. A unidirectionally outward high-volume filtered air flow is generated by the suction pump 17 attached to the air exchange arrangement 16, and additional gaps and openings in and around the flexible skin 14 allow for a steady air flow through the tent cavity without creating an excessive pressure difference between the interior cavity and the surrounding environment.

FIG. 3 shows the expanded tent 10 from below. This view illustrates the positions of the primary bail extending horizontally beyond the open side 20, while the secondary bail is in a position short of the head end 28 of the support base 18. Broken lines added in FIG. 3 indicate the collapsed positions of the primary bail 24 and the secondary bail 26. Additionally, FIG. 3 illustrates how the collapsible tent 10 is sized to be placed on a hospital bed 60, which is schematically shown. The suction pump 17 may be placed next to the hospital bed 60 or on the hospital bed 60 near the head end.

FIG. 4 shows the collapsed configuration of the isolation tent 10 after removal of the skin 16. In the example shown, the support struts are collapsed and accommodated between the lateral portions of the primary and secondary bails 24 and 26. The secondary bail 26 fits inside the curvature of the primary bail 24 so that the primary bail 24 and the secondary bail extend in a common plane that is about parallel to a horizontal plane defined by the support base. The hinge 36 is disposed at a distance of 15 to 20 cm from the hinge 32.

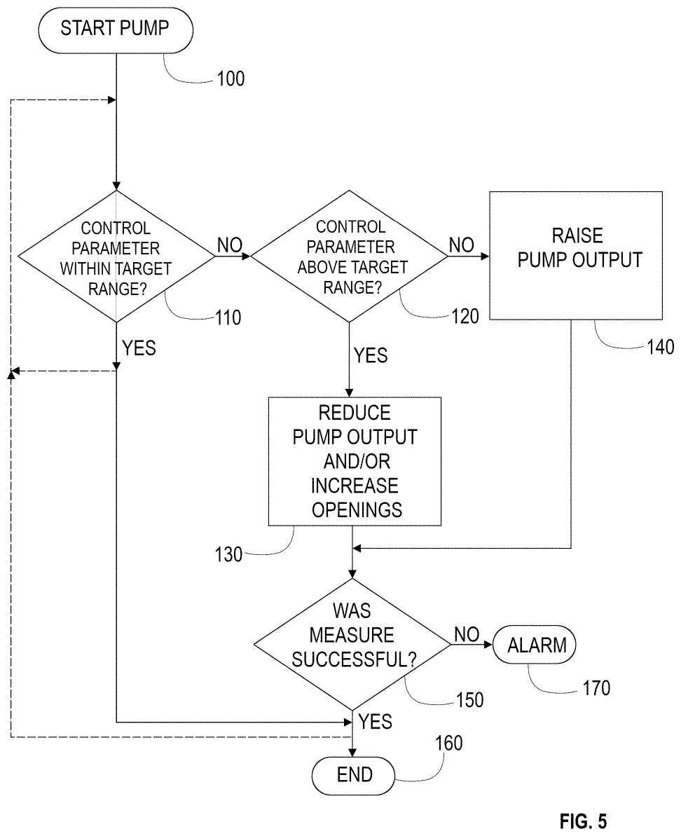

A method of operating the isolation tent 10 with the air pump 17 is schematically shown in the flow chart of FIG. 5. To create an air flow, the air pump 17 is started in step 100. For proper operation, a control parameter is checked to determine whether the control parameter is within a specified target range in step 110. This control parameter target range may be an air flow within the range of 85 per minute through 20,000 liters per minute or any sub-range within this range. The airflow may be inward or outward, depending on the intended function as explained above. Alternatively or additionally the control parameter target range may be a pressure difference (positive or negative) between the interior space and an exterior space within the range of 34 through 17,000 Pa or any sub-range within this range. Additionally, or alternatively, the control parameter may be a number of air exchanges within a given time so that the pump may be operated to exchange the air volume inside the collapsible tent within the range of 0.2 through 100 times per minute or within any sub-range of this range representing the target range.

If the control parameter is within the target range, the method repeats step 110, potentially after a certain time delay, or continuously. Alternatively, the control parameter may only be checked once at the time of setting up the ten assembly without further control once the control parameter is within the target range.

If the control parameter is outside the target range, the method proceeds to step 120, where subsequent steps are determined based on the determination whether the control parameter is above or below the target range. If the control parameter is above the target range, .i.e. if the pumped air volume or the pressure difference or the number of air exchanges are above the target range, different steps are available as outlined in step 130. All three of the mentioned parameters can be lowered by reducing the pump output. The pressure difference can additionally or alternatively reduced by increasing the number of cross-sections of openings extending through the flexible skin of the collapsible tent 10. After such a corrective measure of step 130, the method verifies in step 150 if the control parameter is now within the target range. If this is true, i.e. if the measure of step 130 was successful, the method may be terminated in step 160 or return to step 110 to continually verify that the control parameter remains within the target range. Should the verification in step 150 determine that the corrective measure attempted in step 130 was not successful, at least one of an audible or visual alarm may be activated in step 170 to notify the operator of an error in operation.

If it is determined in step 120 that the control parameter is below the target range, the method continues to step 140, where the pump output is raised to increase the pumped air volume or the pressure difference or the number of air exchanges. After such a corrective measure of step 140, the method returns to step 110 to verify that the control parameter is now within the specified target range. After such a corrective measure of step 140, the method verifies in step 150 if the control parameter is now within the target range. If this is true, i.e. if the measure of step 140 was successful, the method may be terminated in step 160 or return to step 110 to continually verify that the control parameter remains within the target range. Should the verification in step 150 determine that the corrective measure attempted in step 130 was not successful, at least one of an audible or visual alarm may be activated in step 170 to notify the operator of an error in operation.

As mentioned above, the method can continue for the entire time of operation of the air pump 17 or may be terminated once the control parameter or control parameters are within the specified target range. The target ranges may be the broad ranges defined above for proper operability of the tent assembly or may be narrower sub-ranges within the mentioned ranges.

While the above description constitutes the preferred embodiments of the present invention, the invention is susceptible to modification, variation and change without departing from the proper scope and fair meaning of the accompanying claims.

1. A collapsible isolation tent assembly comprising:
a collapsible isolation tent having:
a collapsible frame assembly,
a flexible skin of impermeable material, and
an air exchange arrangement,
a filter, and
an air pump configured for being connected to the air exchange arrangement to effect a unidirectional outward or inward air flow of the air exchange arrangement,
wherein openings in the flexible skin or around edges of the collapsible tent allow for an inward air flow compensating for the unidirectional outward air flow and for an outward air flow compensating for the unidirectional inward air flow.

2. The collapsible isolation tent of claim 1, wherein the collapsible isolation tent is dimensioned to have a footprint with a width within the range of about 35 cm through 140 cm and a length within the range of about 30 cm through 200 cm

3. The collapsible isolation tent of claim 1, wherein the air pump is adjustable to create an air pressure difference between air in an interior space inside the collapsible isolation tent and air in an exterior space surrounding the collapsible isolation tent.

4. The collapsible isolation tent of claim 3, wherein the air pump has a pump capacity within the range of 85 liters per minute through 20,000 liters per minute.

5. The collapsible isolation tent of claim 3, wherein the pressure difference is within a range of 34 Pa to 17,000 Pa.

6. The collapsible isolation tent of claim 3, wherein the collapsible isolation tent and the air pump are dimensioned for exchanging the air in the interior space within a range of 0.2 to 100 times per minute.

7. The collapsible isolation tent assembly according to claim 1, further comprising a filter receptacle upstream of the pump and in communication with the port.

8. The collapsible isolation tent assembly according to claim 7, wherein the filter is a replaceable filter and the filter receptacle is configured to receive the replaceable filter.

9. The collapsible isolation tent assembly according to claim 1, wherein the filter is disposed upstream of the air pump.

10. The collapsible isolation tent assembly according to claim 1, wherein the flexible skin is configured for custom slits and openings being cut by a health care provider for accessing specific locations inside the collapsible isolation tent from an exterior space.

11. The collapsible isolation tent assembly according to claim 1, wherein the collapsible frame assembly includes a support base surrounding an interior area on three of four sides and having one open side, the interior area having a length of about 29 cm to 199 cm and a width between about 34 cm and 139 cm.

12. The collapsible isolation tent assembly according to claim 1, wherein the collapsible frame assembly has an expanded state with an overall height within the range of about 20 cm through 185 cm.

13. The collapsible isolation tent assembly according to claim 1, wherein the flexible skin is translucent or transparent and made of pliable plastic sheeting.

14. The collapsible isolation tent assembly according to claim 1, wherein the flexible skin comprises a drapable curtain.

15. A method for preventing air containing airborne pathogens from contaminating a surrounding space, the method comprising:
operating an air pump in fluid communication with an interior space of a collapsible tent having a footprint sized to be placed on a hospital bed,
wherein the air pump is operated to move air out of or into the interior space of the collapsible tent through a filter suited for removing pathogens from the air moved by the pump.

16. The method of claim 15, further comprising the preceding step of placing the collapsible tent on a surface configured for carrying an infected patient.

17. The method of claim 15, wherein the pump is adjustable and operated to maintain at least one control parameter within a specified range.

18. The method of claim 17, wherein at least one control parameter is air flow and the pump is operated at a capacity to effect the air flow to remain within the range of 85 per minute through 20,000 liters per minute.

19. The method of claim 17, wherein at least one control parameter is a pressure difference between the interior space and an exterior space, wherein the interior space has a lower air pressure than the exterior space, and wherein the pump is operated to maintain the pressure difference within the range of 34 through 17,000 Pa.

20. The method of claim 17, wherein the collapsible tent surrounds an air volume and at least one control parameter is how often the air volume is exchanged per time interval, wherein pump is operated to exchange the air volume within the range of 0.2 through 100 times per minute.

21. The method of claim 17, further comprising the step of activating at least one of an audible, visual, and electronic communication alarm upon determining that any of the at least one control parameter is not maintained within a specified range.

22. The method of claim 15, further comprising the step of cutting access openings in a tent skin.
